(19) United States
(12) Patent Application Publication
(10) Pub. No.: US 2026/0030666 A1
(43) Pub. Date: Jan. 29, 2026

(54) APPLICATION STORE USING GENERATIVE MODELS FOR APPLICATION DISCOVERY

(71) Applicant: Google LLC, Mountain View, CA (US)

(72) Inventors: Andrew Kendall Moore, Portola Valley, CA (US); Xinxin Liu, Sunnyvale, CA (US); Qinmin Wang, Sunnyvale, CA (US); Chao Huang, Fremont, CA (US); Thomas Charles Beagles, Austin, TX (US); Shanshan Duan, Sunnyvale, CA (US); Sanjeev Jagannatha Rao, Sunnyvale, CA (US); Zhong Xiu, Palo Alto, CA (US); Yu Wu, San Jose, CA (US); Lin Han, Campbell, CA (US); Fang Liu, San Francisco, CA (US); Xinnan Yu, New York, NY (US); Isaac Sterling VanDuyn, Brooklyn, NY (US); Steven Taillieu, San Francisco, CA (US); Keishia Chandran Arnott, San Francisco, CA (US); Yuanjian Lai, Mountain View, CA (US); Zuowei Xie, Cupertino, CA (US); Yoshiki Hayashi, San Jose, CA (US); Yuanhao Chen, Santa Clara, CA (US); Xueyu Shi, Foster City, CA (US); Jingwei Ma, Mountain View, CA (US); Lin Sun, Mountain View, CA (US); Zhenyu Shi, Mountain View, CA (US)

(21) Appl. No.: 19/247,962

(22) Filed: Jun. 24, 2025

Related U.S. Application Data
(60) Provisional application No. 63/674,428, filed on Jul. 23, 2024.

(51) Int. Cl. G06Q 30/0601; G06F 9/451

(52) U.S. Cl. CPC G06Q 30/0641; G06F 9/451

(57) ABSTRACT

In one example, a computing system comprises a memory that stores instructions, and processing circuitry that executes the instructions to: generate one or more user interface elements for an application store, wherein the application store hosts a plurality of applications where each application is associated with respective application information; generate intermediary application information by at least providing the application information as input to a first machine learning module, wherein the intermediary application information is a compressed version of the application information and lacks particular subject matter from the application information; generate filtered application information by at least providing the intermediary application information as input to a second machine learning module; receive a request for one or more applications; and responsive to receiving the request, output the filtered application information along with an indication of the one or more applications for presentation within the application store.

This application claims the benefit of U.S. Provisional Patent Application No. 63/674,428, filed Jul. 23, 2024, the entire contents of which is incorporated herein by reference.

### BACKGROUND

Application stores host applications to allow users to download and install the applications to their devices. In some examples, application stores provide search services to allow users to find or discover applications among the applications hosted by the application stores.

### SUMMARY

In general, various aspects of the techniques described in this disclosure are directed to application stores using generative models, such as large language models (LLMs), for application discovery. Application stores, sometimes referred to as “app” stores, may contain a large library of applications (e.g., tens of thousands, hundreds of thousands, millions). Users may struggle to discover (e.g., find and/or download) particular applications because of the sheer volume of available applications. In some cases, users may be unsure of how to search for a particular application they require (e.g., which search terms or keywords to use) and, when presented with application listings, be unclear as to what functionality a particular application provides and/or how one application differs from another.

Some systems allow users to search applications, such as through keyword searching based on search terms inputted by the users. Though resulting search results (e.g., application listing) may include applications related to the users' search terms, these systems may still present an overwhelming number of titles. The systems may allow users to browse through the individual application listings in the search results to reveal developer provided information about a particular application; however, this requires each application to be investigated individually and the information provided for each application may be insufficient for users to decide which application to download.

In accordance with the techniques disclosed herein, a computing system may provide an application store that uses generative models for application discovery. The application store may apply one or more generative models (e.g., LLMs) to generate, for one or more applications, filtered application information that provides insights into the applications. The filtered application information may, for example, identify features provided by the applications, identify and summarize highlights (e.g., good reviews) and/or lowlights (e.g., bad reviews) of the applications, generate answers to questions about the applications for a display page or other user interface element, and provide short summaries of developer or other information about the applications, or various subsets thereof.

The application store may provide multiple types of filtered application information for an application. For example, the application store may identify features and summarize highlights for the application. The application store may present the filtered application information in a particular format (e.g., natural language summary, question and answer, or feature enumeration). By providing the filtered application information, the application store allows users to discover applications for their requirements, even when the application store contains numerous similar applications (e.g., applications within the same or similar category). Though described herein, in some examples, primarily with respect to LLMs, the application store may utilize various generative or other machine learning (ML) models.

In one example, various aspects of the techniques are directed to a method comprising: generating, by a computing system, one or more user interface elements for an application store, wherein the application store hosts a plurality of applications, and wherein each application from the plurality of applications is associated with respective application information; generating, by the computing system, intermediary application information by at least providing the application information as input to a first machine learning module executing at the computing system, wherein the intermediary application information is a compressed version of the application information and lacks particular subject matter from the application information; generating, by the computing system, filtered application information by at least providing the intermediary application information as input to a second machine learning module executing at the computing system; receiving, by the computing system, a request for one or more applications; and responsive to receiving the request, outputting, by the computing system, the filtered application information along with an indication of the one or more applications for presentation within the one or more user interface elements of the application store.

In another example, various aspects of the techniques are directed to a computing system comprising: a memory that stores instructions, and processing circuitry that executes the instructions to: generate one or more user interface elements for an application store, wherein the application store hosts a plurality of applications, and wherein each application from the plurality of applications is associated with respective application information; generate intermediary application information by at least providing the application information as input to a first machine learning module executing at the computing system, wherein the intermediary application information is a compressed version of the application information and lacks particular subject matter from the application information; generate filtered application information by at least providing the intermediary application information as input to a second machine learning module executing at the computing system; receive a request for one or more applications; and responsive to receiving the request, output the filtered application information along with an indication of the one or more applications for presentation within the one or more user interface elements of the application store.

In another example, various aspects of the techniques are directed to non-transitory computer-readable storage media comprising instructions, that when executed by processing circuitry, cause the processing circuitry to: generate one or more user interface elements for an application store, wherein the application store hosts a plurality of applications, and wherein each application from the plurality of applications is associated with respective application information; generate intermediary application information by at least providing the application information as input to a first machine learning module executing at the computing system, wherein the intermediary application information is a compressed version of the application information and lacks particular subject matter from the application information; generate filtered application information by at least providing the intermediary application information as input to a second machine learning module executing at the computing system; receive a request for one or more applications; and responsive to receiving the request, output the filtered application information along with an indication of the one or more applications for presentation within the one or more user interface elements of the application store.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example environment for an application store using generative models for application discovery, in accordance with one or more aspects of the present disclosure.

FIG. 2 is a block diagram illustrating an example environment for an application store using generative models for application discovery, in accordance with one or more aspects of the present disclosure.

FIG. 3 is a block diagram illustrating an example of a machine learning (ML) module, in accordance with one or more aspects of the present disclosure.

FIG. 4A is a block diagram illustrating a first example of a discovery module, in accordance with one or more aspects of the present disclosure.

FIG. 4B is a block diagram illustrating a second example of a discovery module, in accordance with one or more aspects of the present disclosure.

FIG. 5A is a block diagram illustrating a first example of an application store, in accordance with one or more aspects of the present disclosure.

FIG. 5B is a block diagram illustrating a second example of an application store, in accordance with one or more aspects of the present disclosure.

FIG. 6 is a flowchart illustrating an example process for an application store using generative models for application discovery, in accordance with one or more aspects of the present disclosure.

### DETAILED DESCRIPTION

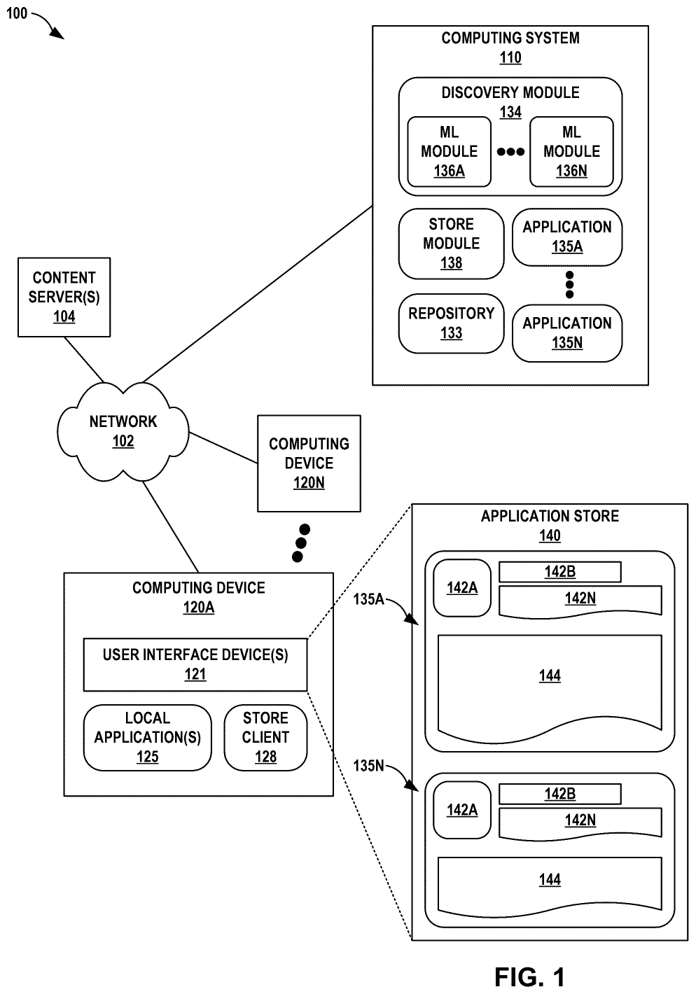

FIG. 1 is a conceptual diagram illustrating an example environment for an application store using generative models for application discovery, in accordance with one or more aspects of the present disclosure. As can be seen from the example of FIG. 1, environment 100 may include one or more computing devices 120A-120N (collectively, “computing devices 120”) that may communicate with computing system 110 over network 102. In some examples, computing devices 120 and computing system 110 may be peer devices that operate in a client/server fashion. For instance, computing devices 120 may be clients that are used to access services, such as application store services (e.g., application search services, download services) of an application store 140 provided by computing system 110.

As such, computing device 120 may enable users to interact with an application store 140 provided by computing system 110. Computing device 120 may be an example of a smartphone, mobile phone, a tablet computer, a laptop computer, a desktop computer, a wearable device, a gaming system, a media player, an e-book reader, camera device, or a wearable computing device (e.g., a computerized watch, computerized eyewear, etc.), or other computing device. FIG. 1 illustrates a particular example of computing device 120, and many other examples of computing device 120 may be used in other instances and may include a subset of the components included in example computing device 120 or may include additional components not shown in FIG. 1.

Computing device 120 may include an operating system that provides an execution environment for store client 128, one or more local applications 125, or both. Local applications 125 may represent applications 135 downloaded from computing system 110, such as through application store 140, that are installed to and/or executed by computing device 120. Examples of applications 135 include social networking applications, utility applications, productivity applications, entertainment applications, creativity applications, communication applications, shopping applications, games, and other software applications.

Store client 128 may interact with application store 140 of computing system 110 and perform other functions associated with applications 135 or local applications 125, including downloading applications 135, installing applications 135, updating local applications 125, and deleting local applications 125, or various subsets thereof. As shown in FIG. 1 for instance, store client 128 may present a representation of application store 140, such as by presenting one or more user interface elements that constitute the representation of application store 140 or a portion (e.g., page, screen) thereof, through user interface device 121 of computing device 120. Application store 140 may include indications of applications 135 that are available, such as for download and/or installation, to computing device 120 through application store 140.

Application store 140 may present applications 135, such as within a page, screen, or other user interface element of application store 140, in various ways. As shown in FIG. 1 for example, application store 140 may present applications 135 in an application listing comprising one or more applications 135. In some examples, the application store may host a plurality of applications 135A-135N (collectively, “applications 135”).

Applications 135 may be hosted along with application information 142A-142N and filtered application information 144. Application information 142 may be information about applications 135 from one or more sources (e.g., application developers, users). Examples of application information include application short form descriptions (e.g., 60 characters or less) and/or long form descriptions (e.g., over 60 characters), application names, application categorizations (e.g., productivity, messaging, social networking, game), application reviews, articles, social media postings, screenshots, icons, promotional content, application summaries, application ratings, and feature descriptions.

As will be described further below, rather than receiving filtered application information 144, computing system 110 may generate filtered application information 144 based on application information 142. In general, computing system 110 may generate filtered application information 144 and present filtered application information 144 to facilitate application discovery at computing devices 120. For example, computing system 110, such as through discovery module 134, may generate filtered application information 144 including summaries, feature enumerations (e.g., feature lists), or questions and answers in natural language format (e.g., English sentences/phrases). Though presented along with the application listing of application store 140 in the example of FIG. 1, filtered application information 144 may be hidden initially and revealed in response to user input, such as at a toggleable (e.g., collapsible) user interface element.

Computing system 110 may invoke discovery module 134 to generate, based on application information 142, filtered application information 144 that includes insights for one or more of applications 135, such as by summarizing features provided by the applications, summarizing highlights (e.g., good reviews) and/or lowlights (e.g., bad reviews) of the applications, presenting questions and answers about applications 135, and providing short summaries of application developer provided information (e.g., application developer descriptions), or various subsets thereof. Discovery module 134 may generate filtered application information 144 such that differences between applications 135, including similar applications 135 (e.g., applications within the same category, subcategory, or both) are readily identifiable.

For example, discovery module 134 may generate filtered application information 144 including feature summaries or feature enumerations for applications 135. By providing filtered application information 144, computing system 110 may provide a compressed (e.g., condensed, abridged, shortened) version of application information 142 about one or more of applications 135 that provides insights into applications. The filtered application information 144 may accordingly include insights into applications 135 while occupying less storage space as compared to application information 142. By publishing (e.g., providing) applications 135 along with filtered application information 144 through application store 140, computing system 110 increases the likelihood that applications 135 are downloaded and/or installed by users. Filtered application information 144 also assists users in determining which application 135 is appropriate for their use case.

Computing device 120 may receive user input (e.g., requests) for store client 128, local applications 125, or both as well as present output of store client 128, local applications 125, or both through one or more user interface devices 121 of computing device 120. User interface device 121 of computing device 120 may be hardware that functions as an input and/or output device for computing device 120. For example, user interface device 121 may include a display component (e.g., liquid crystal display (LCD), organic light-emitting diode (OLED) display), which may be a screen at which information is displayed by user interface device 121 and a presence-sensitive input device that may detect an object at and/or near the display component. The presence-sensitive input device may, for example, detect a user's touch or other input. User interface device 121 may provide tactile, audio, and video output. User interface device 121, in some examples, includes one or more of a presence-sensitive display, speaker, liquid crystal display (LCD), organic light-emitting diode (OLED) display, haptic motors, linear actuating devices, or any other type of device for receiving input or generating output to a human or machine.

Store client 128 may receive user input in various forms (e.g., text input, touch gestures, and other input), such as through user interface device 121. In some examples, store client 128 may receive user input including queries (e.g., search terms), application information (e.g., reviews or ratings), or both. Store client 128 may send at least some of the user input to computing system 110 and computing system 110 may share such user input (e.g., in an anonymized or aggregated form) for purposes such as improving application discovery or training machine learning models.

Computing system 110 may be any suitable computing system, such as one or more desktop computers, laptop computers, mainframes, servers, cloud computing systems, virtual machines, etc. capable of sending and receiving information via network 102. In some examples, computing system 110 may represent a cloud computing system that provides one or more services via network 102. That is, in some examples, computing system 110 may be a distributed computing system. One or more computing devices, such as computing devices 120, may access the services provided by the cloud by communicating with computing system 110. FIG. 1 illustrates only one particular example of computing system 110, and many other examples of computing system 110 may be used in other instances and may include a subset of the components included in example computing system 110 or may include additional components not shown in FIG. 1.

Computing system 110 may include store module 138 that computing system 110 may invoke to provide application store 140. For example, store module 138 may provide an application store by providing one or more application store services, such as to store client 128 of computing devices 120. Store module 138 may publish applications 135 developed by application developers such that computing devices 120 may download applications 135 for installation. Once installed to computing devices 120, application 135 may be represented as a local application 125, as can be seen in the example of FIG. 1. In some examples, store module 138 may process payment information and/or authorizations from computing devices 120, such as to allow purchase prior to download and installation of paid applications 135 or paid features of applications 135.

Store module 138 may publish application listings for applications 135 that, in addition to filtered application information 144, may include application information 142 about applications 135. Each application of applications 135 may have respective application information, which may include technical information about features, functionality, or other characteristics of application 135, promotional content advertising, promoting, marketing, selling, or otherwise enticing users to download and/or install application 135, or other information about application 135.

Store module 138 may receive applications 135 and application information from various sources. For example, store module 138 may receive applications 135 uploaded by application developers and application information 142 provided by application developers. For instance, store module 138 may receive application 135A and application information 142 for application 135A from a first application developer and may receive application 135N and application information 142 for application 135N from an nth application developer. Store module 138 may receive a variety of developer provided application information 142 including the application developer's long form and/or short form text (e.g., summary) promoting or otherwise describing application 135 and/or features thereof, one or more screenshots, icons, or other images, one or more categorizations (e.g., tags) indicating one or more categories (e.g., productivity, messaging, social networking, game) application 135 should be assigned to.

Store module 138 may receive application information 142 from various sources, including application developers. For example, store module 138 may receive application information 142, such as in the form of application feedback (e.g., user reviews, user ratings) from one or more users of applications 135. Store module 138 may receive application feedback for applications 135 from computing devices 120, such as through store client 128 of computing devices 120. Store module 138 may store applications 135, the application information 142 received by store module 138 to one or more storage devices, such as one or more storage devices accessible to computing system 110.

Discovery module 134 may generate filtered application information 144 based on application information 142 for application discovery purposes. Discovery module 134 may use (e.g., process) application information 142 which may include a variety of information about applications 135. Discovery module 134 may use application information 142 of various formats, including tabular (e.g., CSV), indexed (e.g., attribute-value storage of a database or other structured data format), graphical (e.g., images), natural language (e.g., English), or other format suitable to store information about applications 135 that discovery module 134 may be capable of using (e.g., parsing and processing).

Discovery module 134 may obtain application information 142 from various sources. For example, discovery module 134 may obtain application information 142 from repository 133. As described above, repository 133 may store application information 142 that store module 138 receives from application developers, users, or other sources. In some examples, discovery module 134 may obtain application information from a source device connected via network 102. For instance, discovery module 134 may obtain application information 142 from one or more content servers 104 (e.g., web servers) storing and/or hosting information about one or more of applications 135. In some examples, content servers 104 may be part of environment 100, such as shown in FIG. 1. Discovery module 134 may apply contextual passage retrieval to retrieve application information 142 from content servers 104.

Application information 142 may include information about a plurality of applications 135, from one or more sources. For example, applications 135 may have application information 142 including developer provided information stored by repository 133, user reviews stored by repository 133, and articles, reviews, or other information about applications 135 stored by content servers 104, or various subsets thereof. As described above, units of application information 142 may be in different formats (e.g., tabular, indexed, graphical, natural language).

In some examples, discovery module 134 may identify application information 142 from a larger dataset. For instance, discovery module 134 may use information from a number of previous application queries as application information 142. For instance, discovery module 134 may filter particular queries (e.g., the top 1,000, 2,000, 3,000, . . . 10,000 non-navigational queries) to identify a subset of these queries. Discovery module 134 may use the information resulting from the subset of queries as application information 142. In one example, discovery module 134 filters the particular queries to generate a subset of queries that, when executed, each result in 5 high-quality applications 135 with valid application highlights (e.g., three or more positive reviews) in the top 10 impressions (e.g., first 10 results). Discovery module 134 may receive user input to filter queries. For example, discovery module 134 may receive user input indicating whether a query is too broad or whether a query includes sensitive information, with either indication disqualifying the query from inclusion in the subset of queries.

++As part of scaling application discovery and ensuring the quality and relevance of generated filtered application information, computing system 110, through discovery module 134, may implement a multi-stage pipeline for refining the set of user queries used to generate or contextualize filtered application information. This process aims to identify a high-quality corpus of queries for efficient and effective information generation.++

Initially, a large set of queries may be identified, such as the top ‘X’ most popular or relevant queries (e.g., top 1,000, 2,000, 3,000, or more non-navigational queries). This initial set may undergo a series of progressive filtering stages.

The initial set of queries may first be subjected to automated filtering rules. These rules, which may be stored in rules storage 356, can exclude queries based on various criteria such as being too broad, containing sensitive information, or not meeting preliminary quality metrics. An example of a quality metric could be requiring that the query, when executed, results in at least a minimum number of high-quality applications with valid highlights (e.g., at least five applications with positive reviews) appearing within a top ‘k’ number of impressed positions (e.g., top 10 search results). This stage significantly reduces the initial query volume by automatically identifying and removing less desirable queries.

Queries that pass the automated pipeline filtering may then undergo a manual review process. Human operators or designated reviewers may assess a subset of these queries for qualitative aspects not easily captured by automated rules, such as nuance, intent, or potential ambiguity. User input, as described in paragraph [0038], may be incorporated here, where manual flags for queries being “too broad” or “including sensitive information” can lead to their exclusion. This stage provides an additional layer of curation and quality control.

In a subsequent stage, human evaluators may assess the quality of the generated filtered application information associated with the refined queries. This human evaluation provides critical feedback, potentially leading to further refinement of the query corpus or the rules used in earlier filtering stages. Filtered application information may not be published unless it meets a threshold human evaluation score, as described below. This stage serves as a final quality gate and provides valuable data for training and improvement of the ML modules.

This multi-stage filtering process, which sequentially reduces the query corpus, may ensure that the generative models primarily operate on a high-quality and relevant set of queries, which may improve usage of computational resources and human evaluation efforts while enhancing the overall quality and discoverability of applications.

Discovery module 134 may generate filtered application information 144 from application information 142 and store filtered application information 144, such as to repository 133. Store module 138 may publish an application listing including filtered application information 142 for one or more of applications 135 along with indications of the one or more applications. Store client 128 of computing device 120 may request the application listing and present the application listing to users. For example, store module 138 may present filtered application information 144 for one or more of applications 135 along with an indication of the one or more applications. As shown in FIG. 1 for example, application 135A is shown along with application information 142 that provides an indication of application 135A (e.g., application icon, application title, application description) and filtered application information 144 generated for application 135A, which in this example may be a feature summary or feature enumeration.

Discovery module 134 may generate filtered application information 144 for application 135A by identifying a subset of application information 142 about application 135A and using the subset of application information 142 to generate filtered application information 144 particular to application 135A. Discovery module 134 may identify the subset of application information 142 from the overall corpus of application information 142 in various ways. For example, discovery module 134 may select developer provided application information, user ratings, and/or user reviews for application 135A from repository 133 by selecting the application information in repository 133 assigned to application 135A, or an indication thereof. As another example, discovery module 134 may apply one or more ML modules 136A-136N (collectively, “ML modules 136”) to identify the subset of application information 142, such as by classifying application information 142, or portions thereof, as including information about application 135A or not including application 135A.

Discovery module 134 may generate various types of filtered application information 144. For example, discovery module 134 may generate filtered application information 144 comprising a summary of application information 142. For instance, discovery module 134 may generate filtered application information 144 including a summary of application developer application information, such as a long form or short form description of application 135A provided by the application developer. As another example, discovery module 134 may generate filtered application information 144 comprising a summary of highlights and/or lowlights of applications 135A. For instance, to generate filtered application information 144 comprising a summary of highlights, discovery module 134 may generate filtered application information 144 comprising a summary of one or more positive user reviews. Similarly, to generate filtered application information 144 comprising a summary of lowlights, discovery module 134 may generate filtered application information 144 comprising a summary of one or more negative user reviews. In some examples, discovery module 134 may generate filtered application information 144 in question and answer format, where discovery module 134 generates filtered application information 144 including answers to one or more questions that may be asked about application 135A. Discovery module 134 may cluster units of application information 142 together, as will be described further below, such as based on content or sentiment, and generate filtered application information 144 (e.g., highlight/lowlight summaries) based on application information 142 in one or more of the clusters.

Discovery module 134 may generate filtered application information 144 in various formats. For example, discovery module 134 may generate filtered application information 144 including summaries or questions and answers in natural language format (e.g., English sentence(s) or phrase(s)). Discovery module 134 may generate filtered application information 144 in list format in some examples. For instance, discovery module 134 may generate filtered application information 144 comprising a feature enumeration (e.g., list of features) of application 135A based on application information 142 (e.g., developer provided application information). In some examples, discovery module 134 may generate filtered application information 144 in tabular format. For example, discovery module 134 may generate filtered application information 144 for multiple applications 135 in a tabular format where respective features or characteristics form cells of a table that may be compared, such as to identify differences between applications 135.

In some cases, discovery module 134 may generate filtered application information 144 to enhance or replace application information 142. For example, application information 144, such as a short form or long form description provided by an application developer may be of poor quality (e.g., not descriptive, too short, grammatically incorrect). In these cases, discovery module 134 may generate filtered application information 144 including a higher quality version of the application information 144 (e.g., a longer short form or long form description within the character limits of these descriptions). Discovery module 134 may use the poor quality application information 142 to be replaced as input as well as other application information 142 to generate filtered application information 144 to replace the application information 142.

In some examples, store module 138 may identify poor quality application information 142 and automatically invoke discovery module 134 to generate filtered application information 144 to replace such application information. For example, store module 138 may determine short form descriptions, long form descriptions, or both that are below a threshold length (e.g., 30 characters) are too short to be sufficient quality. Discovery module 134 may receive user input that causes discovery module 134 to generate filtered application information 144 to replace poor quality application information 142. Once poor quality application information 142 is replaced, store module 138 may determine application 135A is eligible for promotional placement. For example, application 135A may be a high quality application that, with improved application information 142, would otherwise qualify for promotional placement. As such, once poor quality application information 142 is replaced with filtered application information 144, store module 138 may present application 135 in one or more promotions.

Discovery module 134 may include and manage operation of one or more machine learning (ML) modules 136A-136N (collectively, “ML modules 136”) to generate filtered application information 144. ML module 136 may be or include one or more of various different types of machine-learned models. Examples of such different types of machine-learning models are provided below for illustration. Additional models beyond the example models provided below may be used as well.

One or more of the example ML modules 136 described below may be used, alone or in combination, to provide (e.g., output) filtered application information 144 for one or more of applications 135 in response to input data including application information 142 or indications thereof. In some examples, one or more of the example ML modules 136 may identify a subset of application information 142 to use to generate filtered application information 144. For example, one or more of ML modules 136 may be classification models that receive application information 142 as input and output an indication of which portions of the application information 142 include information about (e.g., describes) or do not include information about (e.g., do not describe) application 135A.

In some implementations, ML module 136 may be or include one or more classifier models such as, for example, linear classification models; quadratic classification models; etc. ML module 136 may be or include one or more regression models such as, for example, simple linear regression models; multiple linear regression models; logistic regression models; stepwise regression models; multivariate adaptive regression splines; locally estimated scatterplot smoothing models; etc. In some examples, ML module 136 may be or include one or more generative networks such as, for example, generative adversarial networks. Generative networks may be used to generate new data such as artificial feedback texts.

In some examples, ML module 136 may be or include one or more artificial neural networks (also referred to simply as neural networks). A neural network may include a group of connected nodes, which also may be referred to as neurons or perceptrons. A neural network may be organized into one or more layers. Neural networks that include multiple layers may be referred to as “deep” networks. A deep network may include an input layer, an output layer, and one or more hidden layers positioned between the input layer and the output layer. The nodes of the neural network may be connected or non-fully connected.

One or more neural networks may be used to provide an embedding within a multi-dimensional embedding space for individual units of application information (e.g., individual application descriptions, features descriptions, reviews, ratings, articles, paragraphs, sentences about application 135A). For example, the embedding may be a representation of knowledge abstracted from input data, such as a unit of application information (e.g., portion of application information), into one or more learned dimensions. In some instances, embeddings may be a useful source for identifying related entities. In some instances, embeddings may be extracted from the output of the network, while in other instances embeddings may be extracted from any hidden node or layer of the network (e.g., a close to final but not final layer of the network).

For example, ML module 136 may utilize an embedding space, such as a multi-dimensional embedding space to determine whether units of application information 142 (e.g., user reviews) include a similar concept. For example, ML module 136 may generate an embedding for each unit of application information 142 that specifies a location for each respective unit of application information 142 within the embedding space based on one or more concepts or sentiment contained in each respective unit of application information 142. ML module 136 may generate the embeddings such that distances in the embedding space correspond to similarity in concepts between units of application information 142. As such, units of application information 142 with similar concepts or sentiment may be separated by smaller distances as compared to units of application information 142 with dissimilar concepts or sentiment which may be separated by relatively larger distances.

ML module 136 may use these embeddings to cluster units of application information 142 with similar concepts together in the embedding space. In some examples, ML module 136 may determine units of application information 142 within a threshold distance of seed include similar concepts or sentiment and determine units of application information 142 beyond the threshold distance to include dissimilar concepts or sentiment. ML module 136 may use clusters of application information 142 to generate filtered application information including review summaries (e.g., highlights/lowlights). For example, ML module 136 may select n largest clusters (e.g., 3 largest clusters) of application information 142 and generate filtered application information 144 using respective application information 142 for each cluster.

In some examples, ML modules 136 may perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc. Computing system 110 may generate ML modules 136 using various training techniques, including supervised, unsupervised, semi-supervised, and reinforcement learning techniques, utilizing one or more training data sets including previous examples of filtered application information. For example, supervised or unsupervised reinforcement learning techniques may be used to generate ML module 136 that, when applied by discovery module 134, generates filtered application information of a selected format (e.g., summary, feature enumeration, question and answer). During training, computing system 110 may validate filtered application information generated by ML module 136 using a validation data set where the filtered application information generated by ML module 136 may be compared to previously validated filtered application information, such as summaries, feature enumerations, or questions and answers validated by human validators. By validating the filtered application information generated by ML module 136, computing system 110 may ensure ML module 136 is of a high quality or at least a satisfactory quality prior to deploying ML module 136 for use with application store 140. Computing system 110 may also validate ML module 136 as part of a feedback loop that continuously improves the quality of the output (e.g., filtered application information 144) of ML module 136.

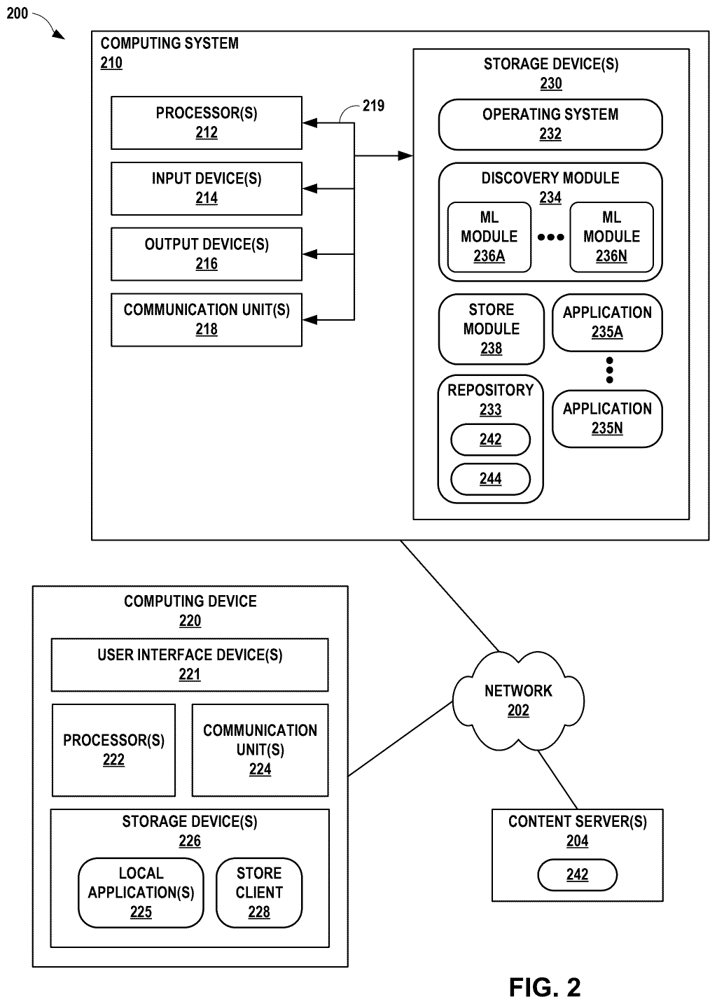

FIG. 2 is a block diagram illustrating an example environment for an application store using generative models for application discovery, in accordance with one or more aspects of the present disclosure. As can be seen from the example of FIG. 2, environment 200 may include a computing device 220 that may communicate with a computing system 210 over network 202. Computing system 210, computing device 220, and network 202 of FIG. 2 are respectively described below as an example of computing system 110, computing devices 120, and network 102 as illustrated in FIG. 1.

Computing system 210 may be any suitable computing system, such as one or more desktop computers, laptop computers, mainframes, servers, cloud computing systems, virtual machines, etc. FIG. 2 illustrates only one particular example of computing system 210, and many other examples of computing system 210 may be used in other instances and may include a subset of the components included in example computing system 210 or may include additional components not shown in FIG. 2.

As shown by the example of FIG. 2, computing system 210 may include one or more processors 212, one or more input devices 214, one or more output devices 216, one or more communication units 218, and one or more storage devices 230. Communication channels 219 may interconnect each of the components 212, 214, 216, 218 and 230 for inter-component communications (physically, communicatively, and/or operatively). In some examples, communication channels 219 may include a system bus, a network connection, an inter-process communication data structure, or any other method for communicating data. Storage device 230 of computing system 210 may include store module 238 and discovery module 234. Computing system 210 may invoke store module 238 to provide an application store, such as application store 140 of FIG. 1 and may invoke discovery module 234 to generate filtered application information 244 from application information 242 for application discovery purposes. Application information 242 and filtered application information 244 of FIG. 2 may respectively be examples of application information 142 and filtered application information 144 as illustrated in FIG. 1

One or more input devices 214 of computing system 210 may receive input. Examples of input are tactile, audio, and video input. Input devices 214 of computing system 210, in one example, includes a presence-sensitive display, touch-sensitive screen, mouse, keyboard, voice responsive system, video camera, microphone or any other type of device for detecting input from a human or machine.

One or more output devices 216 of computing system 210 may generate output. Examples of output are tactile, audio, and video output. Output devices 216 of computing system 210, in one example, includes a presence-sensitive display, sound card, graphics card, speaker, liquid crystal display (LCD), organic light-emitting diode (OLED) display, or any other type of device for generating output to a human or machine.

One or more communication units 218 of computing system 210 may communicate with external devices via one or more wired and/or wireless networks by transmitting and/or receiving network signals on the one or more networks. Examples of one or more communication units 218 include a network interface card (e.g., an Ethernet card), an optical transceiver, a radio frequency transceiver, or any other type of device that can send and/or receive information. Other examples of one or more communication units 218 may include short wave radios, cellular data radios, wireless network radios, as well as universal serial bus (USB) controllers.

Network 202 may represent any public or private communications network, for example, cellular, WI-FI®, and/or other types of networks, for transmitting data between computing systems, servers, and computing devices. Network 202 may include one or more network hubs, network switches, network routers, or any other network equipment, that are operatively inter-coupled thereby providing for the exchange of information between computing system 210 and computing device 220. Computing device 220 and computing system 210 may transmit and receive data across network 202 using any suitable communication techniques. For example, computing system 210 and computing device 220 may communicate (e.g., transmit and receive) applications 235A-235N (collectively, “applications 235”), application information 242, and/or filtered application information 244 via network 202. Each of computing device 220 and computing system 210 may be operatively coupled to network 202 using respective network links, such as Ethernet, Wi-Fi, BLUETOOTH® or any other types of wired and/or wireless network connections.

Store module 238 may provide a protocol (e.g., application programming interface (API) for communicating requests and responses with store client 228. The protocol may include one or more fields for storing filtered application information 244. For example, the protocol may include one or more fields for storing summaries, questions and answers, highlights or lowlights, and feature enumerations or feature summaries, or various subsets thereof. A field may be a named field in some examples. For instance, a field for storing filtered application information 244 including question and answer information may be “AppQuestionAndAnswerInformation.”

One or more processors 212 may implement functionality and/or execute instructions within computing system 210. For example, one or more processors 212 of computing system 210 may receive and execute instructions stored by one or more storage devices 230 that execute the functionality of operating system 232, store module 238, and discovery module 234. The instructions executed by one or more processors 212 may cause computing system 210 to store information within one or more storage devices 230 during program execution. Examples of one or more processors 212 include application processors, display controllers, sensor hubs, and any other hardware configured to function as a processing unit. One or more processors 212 may execute instructions of operating system 232, store module 238, and discovery module 234 to perform actions or functions. That is, operating system 232, store module 238, and discovery module 234 may be operable by one or more processors 212 to perform various actions or functions of computing system 210.

Store module 238 and discovery module 234 of FIG. 2 are respectively described as examples of store module 138 and discovery module 134 as illustrated in FIG. 1. Store module 238 may provide an application store, such as application store 140 of FIG. 1, by providing one or more application store services to computing device 220. Store module 238 may publish applications 235, such as in one or more application listings, along with filtered application information 244 for application discovery purposes. Store module 238 may publish applications 235 such that computing device 220 may download applications 235 for installation. Once installed, applications 235 may be represented as local applications 225. Store module 238 may perform operations described herein using software, hardware, firmware, or a mixture of hardware, software, and firmware residing in and/or executing at computing system 210.

One or more storage devices 230 within computing system 210 may store information for processing during operation of computing system 210. That is, computing system 210 may store data accessed by operating system 232, store module 238, and discovery module 234 during execution at computing system 210, including application information and filtered application information. Computing system 210 may store application information, filtered application information, or both, such as to one or more storage devices 230, that may be accessed by discovery module 234, store module 238, or both during execution at computing system 210.

In some examples, storage device 230 is a temporary memory, meaning that a primary purpose of storage device 230 is not long-term storage. One or more storage devices 230 on computing system 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

One or more storage devices 230, in some examples, also include one or more computer-readable storage media. One or more storage devices 230 may be configured to store larger amounts of information than volatile memory. One or more storage devices 230 may further be configured for long-term storage of information as non-volatile memory space and retain information after power on/off cycles. Examples of non-volatile memories include magnetic hard disks, optical disks, floppy disks, flash memories, or forms of electrically programmable memories (EPROM) or electrically erasable and programmable (EEPROM) memories. One or more storage devices 230 may store program instructions and/or information (e.g., data) associated with operating system 232 and discovery module 234.

In some examples, storage device 230 may include a repository 233 that may implement a database, file format, or other structured data format suitable for storage and retrieval of information, such as application information 242, filtered application information 244, or both. Repository 233 of FIG. 2 may be an example of repository 133 as illustrated in FIG. 1.

Store module 238 may store application information 242 to repository 233 of storage device 230. Repository 233 may store units of application information 242 (e.g., portions of application information) such that each unit of application information 242 is assigned to at least one of applications 235. In this manner, repository 233 may retrieve application information 242 pertinent to a particular application of applications 235. For example, store module 238 may receive a unit of application information 242 including a title and description provided by the application developer of application 235A and/or a review from a user about application 235A. Repository 233 may store such unit(s) of application information 242 along with an indication of application 235A to assign these unit(s) of application information to application 235A. Repository 233 may retrieve the application information pertinent to application 235A (e.g., assigned to application 235A) by querying the application information using the indication of application 235A.

Likewise, discovery module 234 may store filtered application information 144 generated by discovery module 234 to repository 233. Repository 233 may store units of filtered application information 244 (e.g., portions of filtered application information) such that each unit of filtered application information 244 is assigned to at least one of applications 235. In this manner, repository 233 may retrieve filtered application information 244 pertinent to a particular application of applications 235. For example, store module 238 may receive a unit of filtered application information 244 including a summary or feature enumeration generated by discovery module 234. Repository 233 may store such unit(s) of filtered application information 244 along with an indication of application 235A to assign these unit(s) of filtered application information 244 to application 235A. Repository 233 may retrieve filtered application information 244 pertinent to application 235A (e.g., assigned to application 235A) by querying filtered application information 244 using the indication of application 235A.

Discovery module 234 may invoke one or more ML modules 236A-236N (collectively, “ML modules 236”) at least to generate filtered application information 244. One or more ML modules 236 may be used, alone or in combination, to provide (e.g., output) filtered application information 244 for one or more of applications 235 in response to input data including application information 242 or indications thereof. As will be described further below, ML modules 236 may include one or more ML models, including generative models (e.g., LLMs). In some examples, one or more of ML modules 236 may identify a subset of application information 244 to use to generate filtered application information 244. For example, one or more of ML modules 236 may be classification models that receive application information 242 as input and output an indication of which units of application information 242 include or do not include information about application 235A (e.g., information describing application 235A). In some examples, storage device 230 may store one or more of ML modules 236, such as along with or as a part of discovery module 234.

Computing device 220 may be an example of a smartphone, mobile phone, a tablet computer, a laptop computer, a desktop computer, a wearable device, a gaming system, a media player, an e-book reader, camera device, or a wearable computing device (e.g., a computerized watch, computerized eyewear, etc.), or other computing device. FIG. 2 illustrates a particular example of computing device 220, and many other examples of computing device 220 may be used in other instances and may include a subset of the components included in example computing device 220 or may include additional components not shown in FIG. 2.

Computing device 220 includes one or more user interface devices 221, one or more processors 222, one or more storage devices 226, and one or more communication units 224. One or more storage devices 226 of computing device 220 may include an operating system that provides an execution environment for store client 228, one or more local applications 225, or both. As described above, local applications 225 may represent applications 235 downloaded from computing system 210 that are installed to and/or executed by computing device 220.

User interface device 221 of computing device 220 may be hardware that functions as an input and/or output device for computing device 220. For example, user interface device 221 may include a display component (e.g., liquid crystal display (LCD), organic light-emitting diode (OLED) display), which may be a screen at which information is displayed by user interface device 221 and a presence-sensitive input device that may detect an object at and/or near the display component. The presence-sensitive input device may, for example, detect a user's touch or other input. User interface device 221 may provide tactile, audio, and video output. User interface device 221, in some examples, includes one or more of a presence-sensitive display, speaker, liquid crystal display (LCD), organic light-emitting diode (OLED) display, haptic motors, linear actuating devices, or any other type of device for receiving input or generating output to a human or machine.

One or more communication units 224 of computing device 220 may communicate with external devices by transmitting and/or receiving communication signals, such as via one or more wireless networks or wireless connections. Examples of one or more communication units 224 include a network interface card (e.g., Ethernet or WI-FI card), an optical transceiver, a radio frequency transceiver, a global positioning system (GPS) receiver, or any other type of device that can send and/or receive information. Other examples of one or more communication units 224 may include short wave radios, cellular data radios, wireless network radios, as well as universal serial bus (USB) controllers or any other type of device that can send and/or receive information over a wired or wireless connection.

One or more processors 222 may implement functionality and/or execute instructions within computing device 220. For example, one or more processors 222 on computing device 220 may receive and execute instructions stored by one or more storage devices 226 that execute the functionality of store client 228 and local applications 225. The instructions executed by one or more processors 222 may cause computing device 220 to store information within one or more storage devices 226 during program execution. Examples of one or more processors 222 include application processors, display controllers, sensor hubs, and any other hardware configured to function as a processing unit.

One or more storage devices 226 within computing device 220 may store information for processing during operation of computing device 220. That is, computing device 220 may store data accessed by store client 228 during execution at computing device 220, including local applications 225, application information, and other data, or various subsets thereof. In some examples, storage device 226 is a temporary memory, meaning that a primary purpose of storage device 226 is not long-term storage. One or more storage devices 226 on computing device 220 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

One or more storage devices 226, in some examples, also include one or more computer-readable storage media. One or more storage devices 226 may be configured to store larger amounts of information than volatile memory. One or more storage devices 226 may further be configured for long-term storage of information as non-volatile memory space and retain information after power on/off cycles. Examples of non-volatile memories include magnetic hard disks, optical disks, floppy disks, flash memories, or forms of electrically programmable memories (EPROM) or electrically erasable and programmable (EEPROM) memories. One or more storage devices 226 may store program instructions and/or information (e.g., data) associated with store client 228 and local applications 225.

In some examples, one or more storage devices 226 may store an operating system, a store client 228, and one or more local applications 225. Computing device 220 and/or the operating system may provide an execution environment for store client 228 which may send and receive information from computing system 210 to access the application store provided by computing system 210. In some examples, store client 228 may communicate with the store module 238 of computing system 210 to request and receive application store listings including one or more applications, filtered application information 244, and application information 242. Store client 228 may generate data to output a graphical user interface including one or more user interface elements that displays the application listings, such as through user interface device 221.

Store client 228 may perform operations described herein using software, hardware, firmware, or a mixture of hardware, software, and firmware residing in and/or executing at computing device 220 to interact with the application store of computing system 210 as well as other functions associated with applications 235 or local applications 225, including installing applications 235 and/or updating or deleting local applications 225. Computing device 220 may execute local applications 225 with multiple processors or multiple devices, as virtual machines executing on underlying hardware, as one or more services of an operating system or computing platform, and/or as one or more executable programs at an application layer of a computing platform of computing device 220.

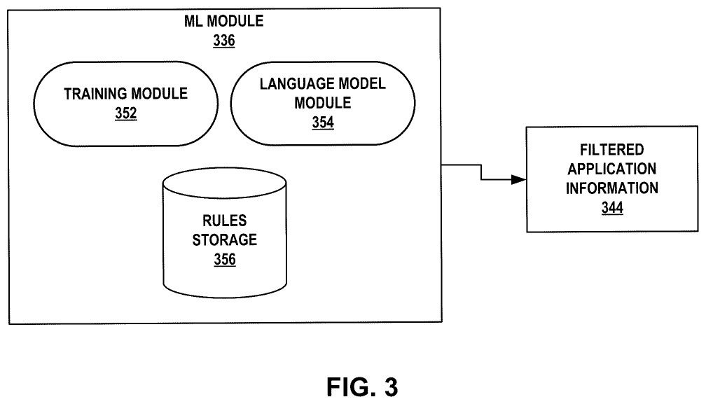

FIG. 3 is a block diagram illustrating an example of an ML module, in accordance with one or more aspects of the present disclosure. FIG. 3 is described below in the context of FIG. 1. ML module 336 of FIG. 3 is respectively described below as an example of ML module 136 as illustrated in FIG. 1. ML module 336 includes language model module 354, training module 352, and rules storage 356. ML module 336 may generate filtered application information 344, which may be an example of filtered application information 144 as shown in FIG. 1. Language model module 354 may include one or more large language models (LLMs).

In general, language model module 354 may accurately perform natural language processing (NLP) tasks, such as generating text and other content. However, with respect to specific types of content (e.g., specific information types), language model module 354 may have an increased likelihood of generating false or inaccurate information. To address the issue of generating false information, language model module 354 may be configured to exclude the generation of content relating to a set of excluded information types. For example, the set of excluded information types may include one or more of promotional material, phone numbers, addresses, web addresses, etc. Thus, language model module 354 may process application information 142 with certain prerequisites, or “rules” that can be stored in rules storage 356. The rules may also be text inputs such as, “What are the main features of the application?”, “Have your summary avoid promotional material.”, and “Keep your summary short.” In this manner, rules storage 356 may store a plurality of rules (e.g., text inputs) that further specify how filtered application information 244 should be generated by language model module 354.

As such, language model module 354 may be applied to structured text (e.g., application information) in accordance with the one or more predefined rules stored in rules storage 356, which may include, for example, one or more of prohibited terms, prohibited topics, or prohibited lengths for filtered application information 344 generated by ML module 336. The rules may include other criteria or instructions by which ML module 336 may generate filtered application information 344. Because language model module 354 can interpret the rules along with the structured text, ML module 336 can provide a more accurate and user-perceptible summary of one or more portions of a comment section of a user application.

ML module 336 may include training module 352 that trains (e.g., pre-train, fine-tune, etc.) language model module 354. Training module 352 may pre-train language model module 354 on a large and diverse corpus of text. This dataset may cover a wide range of topics and domains to ensure language model module 354 learns diverse linguistic patterns and contextual relationships. Training module 352 may train language model module 354 to optimize an objective function. The objective function may be or include a loss function, such as cross-entropy loss, that compares (e.g., determines a difference between) output data generated by the model from the training data and labels (e.g., ground-truth labels) associated with the training data. For example, the objective function of language model module 354 may be to correctly predict the next word in a sequence of words or correctly fill in missing words as much as possible.

In some examples, training module 352 may continuously or periodically train language model module 354. In some examples, training module 352 may fine-tune language model module 354 by using feedback in the training process. For example, store module 138 of FIG. 1 may receive user input through application store 140. The user input may be feedback (e.g., thumbs up, thumbs down, download/installs of applications or lack thereof, etc.) relating to one or more of applications 135 presented with filtered application information 344. In some examples, the feedback may indicate whether the filtered application information 344 is accurate or inaccurate, correct or incorrect, high quality or low quality, results in a download/install of an application, does not result in download/install of an application, etc. Store client 128 may receive the feedback. Further, store client 128 may send the feedback to store module 138 via network 102. Training module 352 of ML module 336 may obtain the feedback, in which training module 352 uses the feedback for training. For example, training module 352 may convert the feedback into labeled data for supervised training. Additionally, or alternatively, training module 352 may fine-tune language model module 354 by monitoring the relationship between the performance of language model module 354 and the feedback, and iterate the fine-tuning process as necessary (e.g., to receive more positive user feedback and less negative user feedback). In this manner, the techniques of this disclosure may establish a feedback loop that continuously improves the quality of the output (e.g., filtered application information 344) of ML module 336.

Though described with reference to language model module 354, which may include one or more LLMs, ML module 336 may include other modules and/or models, including various classification models (e.g., naive Bayes, k-nearest neighbor, support vector machine (SVM), neural networks) or generative models (e.g., diffusion, generative adversarial networks (GAN).

As described above, discovery module 134 may identify application information 142 from a larger dataset. In some examples, discovery module 134 may identify application information 142 by identifying information in the larger dataset based on representativeness, usefulness, and uniqueness. Discovery module 134 may invoke ML module 336 with rules to identify such application information 142, such as by excluding other application information 142 in the output of ML module 336. Examples of such rules include, “Have your summary include representative information,” “Have your summary include useful information,” “Have your summary include unique information,” respectively.

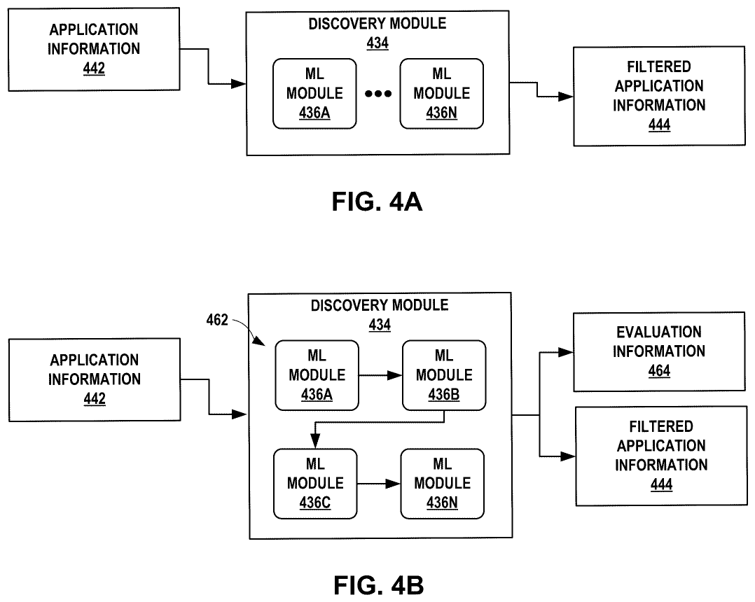

FIG. 4A is a block diagram illustrating a first example of a discovery module, in accordance with one or more aspects of the present disclosure. FIG. 4A is described below in the context of FIG. 1. Discovery module 434 is respectively described below as an example of discovery module 134 as illustrated in FIG. 1. Discovery module 434 includes one or more ML modules 436A-436N (collectively, “ML modules 436”), which may be examples of ML modules 136. Discovery module 434 may generate filtered application information 444 using application information 442 as input. Application information 442 and filtered application information 444 may respectively be examples of application information 142 and filtered application information 144. As described above, discovery module 434 may receive application information 442 from various sources (e.g., repository 133 or content server 104).

Discovery module 434 may invoke one or more ML modules 436 to generate filtered application information 444. Discovery module 434 may invoke a particular ML module of ML modules 436 to generate filtered application information 444. For instance, discovery module 434 may invoke ML module 436A using input comprising application information 442 to generate filtered application information 444. One or more of ML modules 436 may generate particular types of filtered application information 444. For example, discovery module 434 may invoke ML module 436A to generate a summary (e.g., application description summary, highlight/lowlight summary), feature enumeration, and questions and answers, or various subsets thereof using application information 442 as input to ML module 436A. In some examples, discovery module 434 may invoke one or more of ML modules 436 to identify application information 142 (e.g., classify) from a larger dataset.

Discovery module 434 may generate different types of filtered application information 444 at different portions (e.g., pages) of application store 140. For example, discovery module 434 may generate query level information including filtered application information 444 for an application listing (e.g., a search results or highlighted applications page) including a plurality of different applications 135. Discovery module 434 may generate application level information including filtered application information 444 for a particular application of applications 135. For example, discovery module 434 may generate application-level information for a portion (e.g., page) of application store 140 dedicated to the particular application 135A.

In some examples, discovery module 434 may invoke ML modules 436 to generate filtered application information 444 corresponding to application level information and query level information. For example, a first ML module 436A may generate application-level information in the form of filtered application information 444 including summaries or particular types of summaries (e.g., description summaries or review summaries) and a second ML module 436N may generate query level information in the form of filtered application information 144 including feature enumerations.

Discovery module 434 may manage ML modules 436 such as by selecting one or more of ML modules 436 to generate filtered application information 144. For example, discovery module 434 may select and invoke first ML module 436A to generate a summary of an application (e.g., description summary) and select and invoke second ML module 436N to generate a feature enumeration for the application. Discovery module 434 may select first ML module 436A when generating filtered application information 444 for application level information and select second ML module 436B to generate filtered application information 444 for query level information. Discovery module 434 may provide input, such as application information 442, to one or more of ML modules 436 and receive output in the form of filtered application information 444 from ML modules 436.

FIG. 4B is a block diagram illustrating a second example of a discovery module, in accordance with one or more aspects of the present disclosure. Similar to FIG. 4A, FIG. 4B is described below in the context of FIG. 1. As can be seen from the example of FIG. 4B, discovery module 434 may include a pipeline 462 of ML modules 436. For instance, discovery module 434 may include a plurality of linked ML modules 436 where at least one of the ML modules 436 use output from another ML module 436 as input. As shown in the example of FIG. 4B for instance, a first ML module 436A may generate output used by a second ML module 436B and second ML module 436B may generate output used by a third ML module 436C and so on and so forth through an nth ML module 436N. Though illustrated with four ML modules 436 in FIG. 4B, fewer or additional ML modules 436 may constitute a pipeline of ML modules 436. In some examples, discovery module 434 may invoke one or more of ML modules 436 in parallel (e.g., simultaneously). Discovery module 434 may invoke ML modules 436 in various sequences.

One or more of ML modules 436 of pipeline 462 may use intermediary information (e.g., information generated by another ML module 436 as input. For example, a first ML module 436A may extract information from application information 442 (e.g., summarize application information 442 about an application) to generate intermediary application information and second ML module 436B may use the intermediary application information to generate filtered application information 444. By summarizing application information 442, first ML module 436A may provide a compressed version of application information 442 when generating the intermediary application information.

ML modules 436 may apply various rules to extract information from a larger corpus of information. For example, first ML module 436A may apply one or more rules, such as one or more rules of rules storage 356 of FIG. 3, that prohibit promotional content from being included in the intermediary application information. To illustrate, first ML module 436A may generate intermediary application information comprising a compressed version of application information (e.g., a summary) excluding any promotional content. Second ML module 436B may generate filtered application information 444 that does not contain promotional content by generating filtered application information 444 from the intermediary application information.

Pipeline 462 including first ML module 436A and second ML module 436 as described above may provide advantages relative to using a single ML module 436 to generate filtered application information 144 from application information 142. For example, first ML module 436A generates the intermediary application information which may be stored for subsequent use, such as to repository 133. Repository 133 may associate individual units of intermediary application information to respective applications 135. For example, repository 133 may store a unit of intermediary application information along with an indication of application 135 that the unit of intermediary application information describes. Discovery module 434 may generate filtered application information 444 using the intermediary application information rather than raw application information 142. For example, to generate filtered application information 444 for a plurality of applications 135, second ML module 436B may retrieve and use the intermediary application information for each respective application 135 rather than using raw application information 442 of each of application 135.

A single ML module 436 may be limited to processing context of a particular length (e.g., 4,000 or 8,000 tokens), such as based on the compute capacity of computing system 110, which may be quickly saturated by processing raw application information 142. In comparison, with pipeline 462, the intermediary application information provides a compressed version of application information 142 thereby conserving compute resources for processing context and allowing second ML module 436B to generate filtered application information 444 for multiple applications 135, including comparisons of multiple applications without excessive use of computing resources, using the intermediary application information for multiple applications 135.

In another example, pipeline 462 may include first ML module 436A that generates intermediary application information, such as described above. In this example, pipeline 462 may include second ML module 436B. Second ML module 436B may use the intermediary application information generated by ML module 436A to generate filtered application information 444 constituting query level information. For example, second ML module 436B may use the intermediary application information generated by ML module 436A to generate filtered application information 444 including feature enumerations for one or more applications 135 for use as part of search results.

In some cases, query level information may be dependent on the application level information but the application level information may not be dependent on the query level information. This attribute of the query level information and the application level information may result in application store 140 presenting inconsistent filtered application information 444. For example, application store 140 may present query level information, such as on a search results page, for application 135A. When the query level information and the application level information are inconsistent, application store 140 may present filtered application information 444 on the page dedicated to application 135A (e.g., application level information) that is inconsistent with filtered application information 444 for application 135A on the search results page (e.g., query level information).

In some examples, pipeline 462 may include a third ML module 436C to ensure consistency between output (e.g., filtered application information) generated by other ML modules 436. Continuing the above example for instance, third ML module 436C may apply one or more rules, such as rules of rules storage 356 of FIG. 3, to ensure the application level information is consistent with the query level information. In some examples, third ML module 436C may include the query level information (along with application information 442) as input and generate application level information such that the application level information and the query level information are consistent with one another. An example rule to ensure the consistency of application level information may be, “Summarize the application consistent with the query level information.”

Discovery module 434 may utilize zero-shot prompts (e.g., rules without examples or demonstration) as rules at ML modules 436. Continuing the above example for instance, each of first ML module 436A, second ML module 436B, and third ML module 436C may apply rules including zero-shot prompts. To illustrate, first ML module 436A may apply a rule such as “Summarize the application information, but exclude any promotional content,” second ML module 436B may apply a rule such as “List the features of the application using the intermediary application information,” and third ML module 436C may apply a rule such as, “Summarize the application consistent with the query level information.” As can be seen, a rule may refer to application information 442, intermediary application information, or other information. Discovery module 434 may provide the referenced information to the applicable ML module. For example, discovery module 434 may provide application information 424 as input to first ML module 436A to allow first ML module 436A to apply the example rule above (namely, “Summarize the application information, but exclude any promotional content.”) and provide intermediary application information as input to second ML module 436B to allow second ML module 436B to properly apply the example rule above (namely, “List the features of the application using the intermediary application information.).

Discovery module 434 may generate multiple units of filtered application information 444 for a particular application of applications 135. For example, discovery module 434 may generate multiple application description summaries, such as for use as query level information. Store module 138 may select a default unit of filtered application information 444 (e.g., a default summary) to show for an application of applications 135. Store module 138 may select the filtered application information 444 resulting from a particular query (e.g., the most popular query) as the default filtered application information 444.

Discovery module 434 may output evaluation information 464 in some examples, such as through one or more output devices 216 of FIG. 2. Evaluation information 464 may be used for human evaluation of filtered application information 444 generated by discovery module 434. For example, discovery module 434 may generate evaluation information 464 including citations and/or explanations for information in filtered application information 444. Evaluation information 464 may include a description of the amount of coverage (e.g., breadth) of filtered application information 444, distinctiveness of filtered application information 444, or both. A human evaluator may use the evaluation information 464 to validate filtered application information 444. In some examples, application store 140 may not publish filtered application information 444 unless it is first validated by a human evaluator. Discovery module 434, store module 138, or both may receive input from a human evaluator that indicates whether particular filtered application information 444 has or has not been validated.

In some examples, discovery module 434 may use evaluation information 464 to generate filtered application information 444. For instance, discovery module 434 may use explanations, coverage, and distinctiveness indications from evaluation information 464 to trigger the “chain of thoughts” effect for LLMs of ML modules 436, resulting in a better basis to generate filtered application information 444 and higher quality filtered application information 444.

As described above, discovery module 434 may generate filtered application information 444 and store filtered application information 444, such as to repository 133 for retrieval and presentation by store module 138 in application store 140. Discovery module 434 may selectively present filtered application information 444 for a subset of applications 135. For example, discovery module 434 may generate a filtered application information 444, such as based on application information 442 corresponding to search results of particular queries, such as popular queries received by store module 138 (e.g., top 1,000, 2,000, 3,000, . . . 10,000 non-navigational queries). As described above, discovery module 134 may filter the particular queries to generate a subset of queries that, when executed, each result in 5 high-quality applications 135 with valid application highlights (e.g., three or more positive reviews) in the top 10 impressions (e.g., first 10 results). Discovery module 434 may generate filtered application information 444 using the particular queries, filtered or unfiltered.

To expand the number of applications 135 with filtered application information 444, discovery module 434 may expand the corpus of particular queries to include additional queries. For example, rather than using the top 1,000 queries, discovery module 434 may generate filtered application information 444 using the top 2,000 or 3,000 queries. By expanding the query corpus, discovery module 434 can generate filtered application information 444, such as highlight summaries, for additional applications, including new applications.

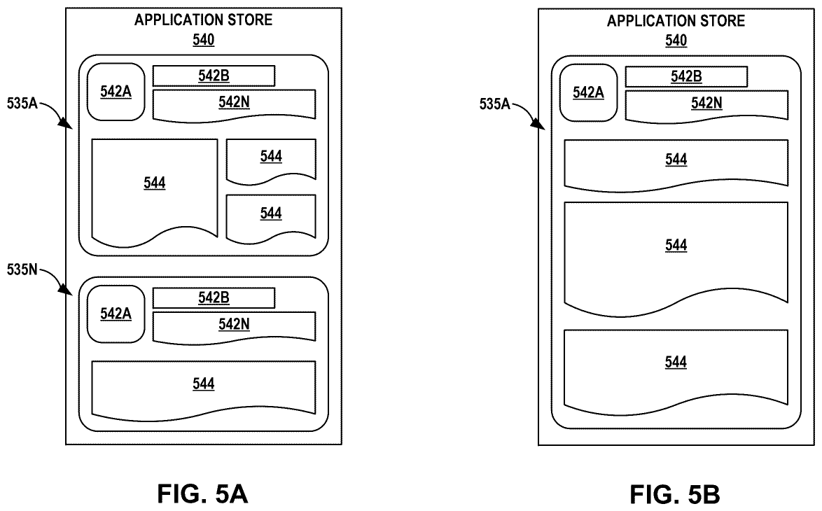

FIG. 5A is a block diagram illustrating a first example of an application store, in accordance with one or more aspects of the present disclosure. FIG. 5A is described below in the context of FIG. 1. Application store 540, applications 535, application information 542, and filtered application information 544 of FIG. 5 may respectively be examples of application store 140, applications 135, application information 142, and filtered application information 144 of FIG. 1. Application store 540 may be provided by store module 138.

Application store 540 of FIG. 5A may represent an example of query level information. As can be seen, application store 540 presents a user interface element including an application listing for a plurality of applications 535. The query level information may include filtered application information 544 for each application 535. For example, filtered application information 544 of FIG. 5A may include feature enumerations and/or summaries highlighting features or other characteristics of applications 535.

In some examples, filtered application information 544 may only be presented for a limited number of applications 535 in an application listing. For example, filtered application information 544 may be presented for the first (e.g., top) n results of a query submitted to application store 540. As described above, ML module 136 of discovery module 134 may generate filtered application information 544 including summaries of particular user reviews (e.g., reviews with the most positive or negative feedback, reviews with the most views) as highlights or lowlights of application 535.

As can be seen, application store 540 may present application information 542, such as application titles and descriptions provided by application developers. In the example of FIG. 5A for instance, application information 542N may be a description of corresponding application 535. As described above, application information 542N may be of poor quality in some cases. As such, application store 540 may replace such application information 542 by presenting filtered application information 544 in the place of such application information 542. For example, application store 540 may present filtered application information 544 including a description of application 535 rather than application information 542N. In such a case, filtered application information 544 may occupy the space within the user interface element of application store 540 otherwise reserved for application information 542N. Application store 540 may present an indication of the source of the description. For example, only application information 542 may be presented with an indication (e.g., citation) identifying the application developer or publisher of application 535 as the source of the description.

FIG. 5B is a block diagram illustrating a second example of an application store, in accordance with one or more aspects of the present disclosure. Similar to FIG. 5A, FIG. 5B is described below in the context of FIG. 1. Application store 540 of FIG. 5B may represent an example of application level information. As can be seen, application store 540 presents a user interface dedicated to application 535A along with filtered application information 544 for application 535A. For example, filtered application information 544 of FIG. 4B may include feature enumerations, summaries, and questions and answers, or various subsets thereof. Summaries may include summaries of developer provided information or user reviews/ratings.

In some examples, application store 540 may determine whether an application is one of local applications 125 (e.g., installed) or one of applications 135 (e.g., not installed). Application store 540 may present different information for local applications 125 (e.g., installed applications) as compared to applications 135 hosted on application store 140 that have not been installed. For example, application store 140 may present filtered application information 544 including feature enumerations, highlights, or both for applications 135 and present filtered application information 544 including questions and answers for local applications 125. Application store 140 may hide particular types of filtered application information 144 for applications 135. For example, filtered application information 544 including questions and answers for applications 135 may be hidden until toggled, such as by engaging a user interface element (e.g., button) and shown by default for local applications 125. Application store 140 may present different sets of questions and answers for applications 135 versus local applications 125. Application store 140 may present questions and answers in a collapsible user interface whereby answers are hidden until corresponding questions are selected (e.g., tapped or clicked). In some examples, the collapsible user interface may automatically collapse to hide one or more answers. Discovery module 134 may generate filtered application information 544 in response to user input to show questions and answers or other filtered application information 544.

Though described in connection with FIGS. 5A and 5B respectively as part of query level information and application level information, in some examples, filtered application information 544 forming query level information of FIG. 5A may be filtered application information 544 forming application level information, such as the application level information of FIG. 5B, and vice versa. Though described with reference to particular types of filtered application information 544, various types of filtered application information 544 may be presented as described above. For example, in addition to questions and answers, summaries (e.g., application highlights), feature enumerations, or both may be hidden until toggled or presented through a collapsible or other user interface element that shows or hides these types of filtered application information 544 based on user input to toggle the presentation of such filtered application information 544.

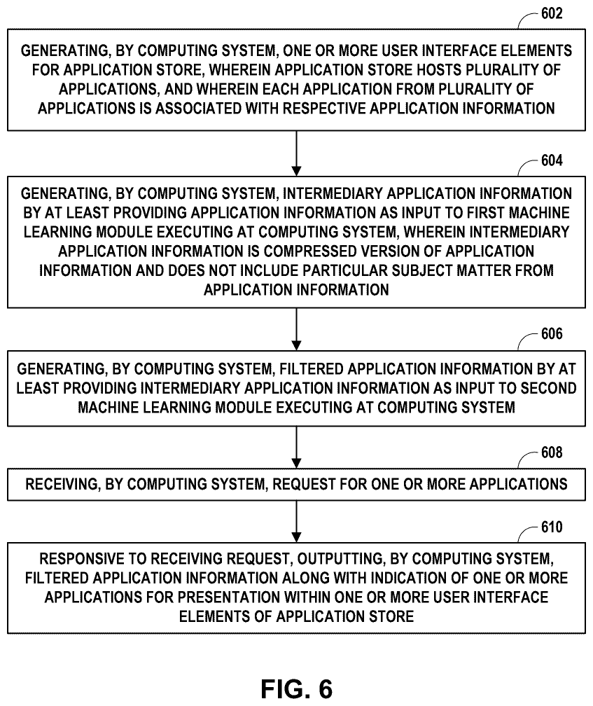

FIG. 6 is a flowchart illustrating an example process for an application store using generative models for application discovery, in accordance with one or more aspects of the present disclosure. FIG. 6 is described below in the context of FIG. 1.

Computing system 110 may generate one or more user interface elements for an application store 140 hosting a plurality of applications 135 (602). Each of applications 135 may be associated with respective application information 142. Examples of application information 142 include application short form descriptions (e.g., 60 characters or less) and/or long form descriptions (e.g., over 60 characters), application names, application categorizations (e.g., productivity, messaging, social networking, game), application reviews, articles, social media postings, screenshots, icons, promotional content, application summaries, application ratings, and feature descriptions.

Computing system 110 may generate intermediary application information by at least providing application information 142 as input to first ML module 136A executing at computing system 110 (604). The intermediary application information may be a compressed version of the application information 142 and lacks particular subject matter from application information 142. For example, computing system 110, using first ML module 136A, may generate a compressed version of application information 142 by generating a summary of application information 142. Computing system 110 may generate the intermediary application information that lacks the particular subject matter by applying, using first ML module 136A, one or more rules to exclude the particular subject matter from the application information when generating summaries constituting the intermediary application information. In some examples, the particular subject matter may include promotional content (e.g., marketing or advertising content).

Computing system 110 may generate filtered application information 144 by at least providing the intermediary application information as input to second ML module 136B executing at computing system 110 (606). This filtered application information 144 may be considered first filtered application information, which may correspond to query level information (e.g., for a search results page). Computing system 110 may also generate second filtered application information by providing the intermediary application information as input to third ML module 136C executing at computing system 110. In this example, the second filtered application information may be considered application level information (e.g., for a page dedicated to an application of applications 135). To generate the second filtered application information, computing system 110 may apply, using third ML module 136C, one or more rules to at least first filtered application information 144 to ensure the second filtered application information is consistent with first filtered application information 144. Filtered application information 144 may include one or more of an application summary, questions and answers, or feature enumerations

Computing system 110 may receive a request for one or more applications of applications 135 (608). For example, computing system 110 may receive a request in the form of a query from computing devices 120. Computing system 110 may, responsive to receiving the request, output filtered application information 144 along with an indication of the one or more applications 135 for presentation within the one or more user interface elements of the application store 140 (610). For example, computing system 110 may output an application listing including indications of one or more applications 135 along with filtered application information 144 for one or more applications 135.

In some examples, computing system 110 may output different filtered application information 144 based on whether application 135A is or is not a local application 125 (e.g., is installed to computing device 120). As such, to output filtered application information 144 computing system 110 may output a first subset of the filtered application 144 (e.g., first set of questions and answers) when one or more applications 135 are not one or more local applications 125 and output a second subset of the filtered application information 144 (e.g., second set of questions and answers) when one or more applications 135 are one or more local applications 125. The one or more user interface elements of application store 140 may be toggleable to show and hide the filtered application information.

Where some application information is of poor quality, computing system 110 may replace at least some of application information 142 with filtered application information 144. For example, computing system 110 may replace some of application information 142 (e.g., a poor short form or long form description provided by an application developer) that computing system 110 determines is of poor quality (e.g., too short). Computing system 110 may generate filtered application 144 as a replacement of such application information 142 in these examples. In some examples, computing system 110 may generate filtered application information 144 that is longer than the replaced application information 142 and shorter than a threshold text size (e.g., 60 characters, 500 characters). In this manner, computing system 110 may generate short form or long form descriptions within the text size limit of application store 140 for such information.

In some examples, computing system 110 may cluster, within a multi-dimensional embedding space, the application information 142 into a plurality of clusters based on sentiment contained within the application information. Computing system 110 may generate, for each cluster of the plurality of clusters, at least some of the filtered application information based on the application information within the cluster.

In some examples, one or more processors 212 execute discovery module 234, store module 238, or both to provide the functionality described above with respect to the flowchart of FIG. 6.

Aspects of this disclosure include the following examples.

Example 1: A method includes generating, by a computing system, one or more user interface elements for an application store, wherein the application store hosts a plurality of applications, and wherein each application from the plurality of applications is associated with respective application information; generating, by the computing system, intermediary application information by at least providing the application information as input to a first machine learning module executing at the computing system, wherein the intermediary application information is a compressed version of the application information and lacks particular subject matter from the application information; generating, by the computing system, filtered application information by at least providing the intermediary application information as input to a second machine learning module executing at the computing system; receiving, by the computing system, a request for one or more applications; and responsive to receiving the request, outputting, by the computing system, the filtered application information along with an indication of the one or more applications for presentation within the one or more user interface elements of the application store.

Example 2: The method of example 1, wherein the filtered application information is first filtered application information, the method further comprising generating, by the computing system and using a third machine learning module, second filtered application information based on the intermediary application information.

Example 3: The method of example 2, wherein generating the second filtered application information comprises applying, by the third machine learning module, one or more rules to the first filtered application information to ensure the second filtered application information is consistent with the first filtered application information.

Example 4: The method of example 1, wherein generating the intermediary application information comprises applying, by the first machine learning module, one or more rules to exclude the particular subject matter from the application information.

Example 5: The method of example 4, wherein the particular subject matter comprises promotional content.

Example 6: The method of example 1, wherein the filtered application information includes one or more of an application summary, questions and answers, or feature enumerations.

Example 7: The method of example 1, further comprising replacing, by the computing system, at least some of the application information with the filtered application information.

Example 8: The method of example 1, wherein the one or more user interface elements of the application store are toggleable to show and hide the filtered application information.

Example 9: The method of example 1, wherein outputting the filtered application information comprises outputting a first subset of the filtered application when the one or more applications are not one or more local applications and outputting a second subset of the filtered application information when the one or more applications are the one or more local applications.

Example 10: The method of example 1, further includes clustering, by the computing system and within a multi-dimensional embedding space, the application information into a plurality of clusters based on sentiment; and generating, by the computing system and for each cluster of the plurality of clusters, at least some of the filtered application information based on the application information within the cluster.

Example 11: A computing system includes a memory that stores instructions; and processing circuitry that executes the instructions to: generate one or more user interface elements for an application store, wherein the application store hosts a plurality of applications, and wherein each application from the plurality of applications is associated with respective application information; generate intermediary application information by at least providing the application information as input to a first machine learning module executing at the computing system, wherein the intermediary application information is a compressed version of the application information and lacks particular subject matter from the application information; generate filtered application information by at least providing the intermediary application information as input to a second machine learning module executing at the computing system; receive a request for one or more applications; and responsive to receiving the request, output the filtered application information along with an indication of the one or more applications for presentation within the one or more user interface elements of the application store.

Example 12: The computing system of example 11, wherein the filtered application information is first filtered application information and the processing circuitry executes the one or more instructions to generate, using a third machine learning module, second filtered application information based on the intermediary application information.

Example 13: The computing system of example 12, wherein to generate the second filtered application information comprises the processing circuitry executes the one or more instructions to apply, using the third machine learning module, one or more rules to the first filtered application information to ensure the second filtered application information is consistent with the first filtered application information.

Example 14: The computing system of example 11, wherein to generate the intermediary application information the processing circuitry executes the one or more instructions to apply, using the first machine learning module, one or more rules to exclude the particular subject matter from the application information.

Example 15: The computing system of example 14, wherein the particular subject matter comprises promotional content.

Example 16: The computing system of example 11, wherein the filtered application information includes one or more of an application summary, questions and answers, or feature enumerations.

Example 17: The computing system of example 11, where the processing circuitry executes the one or more instructions to replace at least some of the application information with the filtered application information.

Example 18: The computing system of example 11, wherein the one or more user interface elements of the application store are toggleable to show and hide the filtered application information.

Example 19: The computing system of example 11, wherein to output the filtered application information the processing circuitry executes the one or more instructions to output a first subset of the filtered application when the one or more applications are not one or more local applications and output a second subset of the filtered application information when the one or more applications are the one or more local applications.

Example 20: Non-transitory computer-readable storage media includes instructions that, when executed by processing circuitry, cause the processing circuitry to: generate one or more user interface elements for an application store, wherein the application store hosts a plurality of applications, and wherein each application from the plurality of applications is associated with respective application information; generate intermediary application information by at least providing the application information as input to a first machine learning module executing at the computing system, wherein the intermediary application information is a compressed version of the application information and lacks particular subject matter from the application information; generate filtered application information by at least providing the intermediary application information as input to a second machine learning module executing at the computing system; receive a request for one or more applications; and responsive to receiving the request, output the filtered application information along with an indication of the one or more applications for presentation within the one or more user interface elements of the application store.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while disks reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

It is to be recognized that, depending on the example, certain acts or events of any of the methods described herein may be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A method comprising:
generating, by a computing system, one or more user interface elements for an application store, wherein the application store hosts a plurality of applications, and wherein each application from the plurality of applications is associated with respective application information;
generating, by the computing system, intermediary application information by at least providing the application information as input to a first machine learning module executing at the computing system, wherein the intermediary application information is a compressed version of the application information and lacks particular subject matter from the application information;
generating, by the computing system, filtered application information by at least providing the intermediary application information as input to a second machine learning module executing at the computing system;
receiving, by the computing system, a request for one or more applications; and
responsive to receiving the request, outputting, by the computing system, the filtered application information along with an indication of the one or more applications for presentation within the one or more user interface elements of the application store.

2. The method of claim 1, wherein the filtered application information is first filtered application information, the method further comprising generating, by the computing system, second filtered application information by at least providing the intermediary application information as input to a third machine learning module.

3. The method of claim 2, wherein generating the second filtered application information comprises applying, by the third machine learning module, one or more rules to at least the first filtered application information to ensure the second filtered application information is consistent with the first filtered application information.

4. The method of claim 1, wherein generating the intermediary application information comprises applying, by the first machine learning module, one or more rules to exclude the particular subject matter from the application information.

5. The method of claim 4, wherein the particular subject matter comprises promotional content.

6. The method of claim 1, wherein the filtered application information includes one or more of an application summary, review summary, questions and answers, or feature enumerations.

7. The method of claim 1, wherein the one or more user interface elements of the application store are toggleable to show and hide the filtered application information.

8. The method of claim 1, wherein outputting the filtered application information comprises outputting a first subset of the filtered application when the one or more applications are not one or more local applications and outputting a second subset of the filtered application information when the one or more applications are the one or more local applications.

9. The method of claim 1, further comprising replacing, by the computing system, at least some of the application information with the filtered application information.

10. The method of claim 9, wherein the filtered application information is longer than the at least some of the application information and shorter than a threshold text size.

11. A computing system comprising:
a memory that stores instructions; and
processing circuitry that executes the instructions to:
generate one or more user interface elements for an application store, wherein the application store hosts a plurality of applications, and wherein each application from the plurality of applications is associated with respective application information;
generate intermediary application information by at least providing the application information as input to a first machine learning module executing at the computing system, wherein the intermediary application information is a compressed version of the application information and lacks particular subject matter from the application information;
generate filtered application information by at least providing the intermediary application information as input to a second machine learning module executing at the computing system;
receive a request for one or more applications; and
responsive to receiving the request, output the filtered application information along with an indication of the one or more applications for presentation within the one or more user interface elements of the application store.

12. The computing system of claim 11, wherein the filtered application information is first filtered application information and the processing circuitry executes the one or more instructions to generate second filtered application information by at least providing the intermediary application information as input to a third machine learning module.

13. The computing system of claim 12, wherein to generate the second filtered application information comprises the processing circuitry executes the one or more instructions to apply, using the third machine learning module, one or more rules to at least the first filtered application information to ensure the second filtered application information is consistent with the first filtered application information.

14. The computing system of claim 11, wherein to generate the intermediary application information the processing circuitry executes the one or more instructions to apply, using the first machine learning module, one or more rules to exclude the particular subject matter from the application information.

15. The computing system of claim 14, wherein the particular subject matter comprises promotional content.

16. The computing system of claim 11, wherein the filtered application information includes one or more of an application summary, review summary, questions and answers, or feature enumerations.

17. The computing system of claim 11, wherein the one or more user interface elements of the application store are toggleable to show and hide the filtered application information.

18. The computing system of claim 11, where the processing circuitry executes the one or more instructions to replace at least some of the application information with the filtered application information.

19. The computing system of claim 11, wherein to output the filtered application information the processing circuitry executes the one or more instructions to output a first subset of the filtered application when the one or more applications are not one or more local applications and output a second subset of the filtered application information when the one or more applications are the one or more local applications.

20. Non-transitory computer-readable storage media comprising instructions, that when executed by processing circuitry, cause the processing circuitry to:
generate one or more user interface elements for an application store, wherein the application store hosts a plurality of applications, and wherein each application from the plurality of applications is associated with respective application information;
generate intermediary application information by at least providing the application information as input to a first machine learning module executing at the computing system, wherein the intermediary application information is a compressed version of the application information and lacks particular subject matter from the application information;
generate filtered application information by at least providing the intermediary application information as input to a second machine learning module executing at the computing system;
receive a request for one or more applications; and
responsive to receiving the request, output the filtered application information along with an indication of the one or more applications for presentation within the one or more user interface elements of the application store.
